(19) United States
(12) Patent Application Publication
(10) Pub. No.: US 2020/0057501 A1
(43) Pub. Date: Feb. 20, 2020

(54) System, devices, and methods for remote projection of haptic effects

(71) Applicant: IMMERSION CORPORATION, San Jose, CA (US)

(72) Inventor: Robert A. Lacroix, Saint-Lanbert (CA)

(21) Appl. No.: 15/998,490

(22) Filed: Aug. 16, 2018

(51) Int. Cl. G06F 3/01; G06F 3/033

(52) U.S. Cl. CPC G06F 3/016; G06F 3/017; G06F 3/033

(57) ABSTRACT

Systems, devices, and methods for remote projection of haptic effects are provided. The systems and devices include ultrasonic arrays, positioning devices, and target sensors. The target sensors detect the presence, location, and movement of potential haptic targets. The positioning devices are configured to orient the ultrasonic arrays towards the haptic targets detected by the target sensors. The ultrasonic arrays are configured to produce an ultrasonic beam configured to project a haptic effect at a remote location.

### FIELD OF THE INVENTION

Embodiments hereof relate to devices and methods for remote projection of haptic effects. In particular, embodiments hereof include positionable ultrasonic arrays configured to cause haptic effects at locations remote from the ultrasonic arrays. Further embodiments hereof include system elements configured to facilitate the remote projection of haptic effects by the ultrasonic arrays.

### BACKGROUND OF THE INVENTION

Conventional haptic effect provision techniques typically require user contact with a haptically enabled device. Haptically enabled devices may be wearable or handheld and are capable of providing haptic effects to portions of a user's body in contact therewith. Thus, to provide haptic effects at a specific part of the user's body can require a haptically enabled device specifically configured to contact and affect that part of the body. This requirement both limits the range of body parts to which haptic effects may be applied and creates the inconvenient requirement of wearing or holding specific gear.

These and other drawbacks exist with conventional contact based haptically enabled devices and wearables. These drawbacks are address by the inventions described herein.

### BRIEF SUMMARY OF THE INVENTION

Embodiments of the invention include systems, devices, and methods for the remote projection of haptic effects. A user interacting with systems for the remote projection of haptic effects is not required to wear or hold any haptically enabled devices. Ultrasonic arrays are employed to project ultrasonic beams through the air that cause haptic effects where they intersect with a body part(s) of the user. The ultrasonic arrays are positioned and oriented by the system to provide the remote haptic effects at any selected location on the user's body. In embodiments, systems for the remote projection of haptic effects are employed in conjunction with virtual reality, augmented reality, and/or mixed reality systems (collectively, VAMR systems) and increase the immersive feel of the VAMR environment by permitting the application of haptic effects anywhere on the user's body without the need for intrusive wearable or handheld devices. In embodiments, systems for the remote projection of haptic effects are employed in desktop environments, in conjunction with the use of a display screen and/or a VAMR headset device, to create a haptically enabled interaction volume within which haptic effects are projected. In embodiments, systems for the remote projection of haptic effects are employed in room size environments or larger, in conjunction with the use of a display screen and/or a VAMR headset device, to create a haptically enabled interaction volume large enough to encompass the entire body of a person and to permit their movement within the volume.

In an embodiment, a system for projecting haptic effects is provided. The system includes an ultrasonic array mounted on a positioning device; a sensor configured to detect a target object and output target object information; and a processor. The processor is configured to receive the target object information from the sensor, select a haptic target according to the target object information, determine a location of the haptic target based on the target object information, provide an orientation signal to the positioning device, the orientation signal being configured to cause the positioning device to orient the ultrasonic array towards the haptic target, and provide a control signal to cause the ultrasonic array to emit an ultrasonic beam to cause a haptic effect at the haptic target.

In further embodiments, a method for projecting haptic effects is provided. The method includes detecting, with a sensor, a target object; outputting, from the sensor, target object information related to the target object; receiving, with a processor, the target object information from the sensor; selecting, with the processor, a haptic target according to the target object information; determining, with the processor, a location of the haptic target based on the target object information; providing, with the processor, an orientation signal to a positioning device; orienting, with the positioning device, an ultrasonic array according to the orientation signal; and providing, with the processor, a control signal configured to cause the ultrasonic array to cause a haptic effect at the haptic target.

### BRIEF DESCRIPTION OF DRAWINGS

The foregoing and other features and advantages of the invention will be apparent from the following description of embodiments hereof as illustrated in the accompanying drawings. The accompanying drawings, which are incorporated herein and form a part of the specification, further serve to explain the principles of the invention and to enable a person skilled in the pertinent art to make and use the invention. The drawings are not to scale.

FIG. 1 illustrates a haptic effect remote projection system according to an embodiment hereof.

FIG. 2 is a schematic diagram illustrating additional aspects of the haptic effect remote projection system of FIG. 1.

FIGS. 3A-3C illustrate structural and operation aspects of an ultrasonic array consistent with an embodiment hereof.

FIG. 4 illustrates operation of the haptic effect remote projection system according to an embodiment hereof.

FIG. 5 illustrates features of a positioning device of a haptic effect remote projection system according to an embodiment hereof.

FIG. 6 illustrates features of a positioning device of a haptic effect remote projection system according to an embodiment hereof.

FIG. 7 illustrates a haptic effect remote projection system according to an embodiment hereof.

FIG. 8 illustrates a haptic effect remote projection system according to an embodiment hereof.

FIG. 9 is a process diagram illustrating a process of remotely projecting haptic effects in accordance with an embodiment hereof.

### DETAILED DESCRIPTION OF THE INVENTION

Specific embodiments of the present invention are now described with reference to the figures. The following detailed description is merely exemplary in nature and is not intended to limit the invention or the application and uses of the invention. Furthermore, there is no intention to be bound by any expressed or implied theory presented in the preceding technical field, background, brief summary or the following detailed description.

Embodiments of the present invention are directed to providing targeted, remotely projected haptic effects. Haptic effect remote projection systems in accordance with embodiments described herein include ultrasonic arrays mounted to positioning devices and controlled, via a system processor, to cause haptic effects at target locations remote from the ultrasonic arrays without any requirement for a wearable or handheld device. One or more sensors associated with the system track the presence, location, and movement of a body part(s) of a user interacting with the system. The system processor analyzes the information from the sensor(s) and uses it to provide an orientation signal to actuators of the positioning devices to position and orient the positioning devices so as to point the ultrasonic arrays towards a haptic target, i.e., a user body part selected to receive a haptic effect. The processor then provides a control signal to the ultrasonic arrays to cause the projection of an ultrasonic beam configured to cause a haptic effect at the remote haptic target. The embodiments discussed below provide greater detail on aspects of the haptic effect remote projection system.

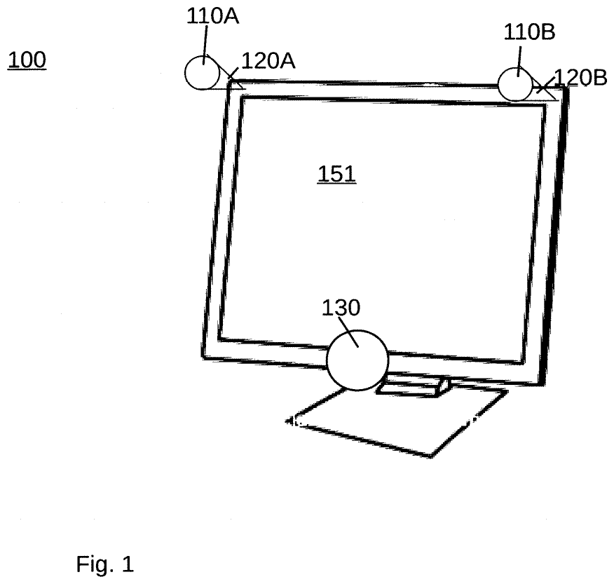

FIG. 1 illustrates a haptic effect remote projection system 100 according to an embodiment. The haptic effect remote projection system 100 includes one or more ultrasonic arrays 110A, 110B, each mounted on a corresponding positioning device 120A, 120B. The haptic effect remote projection system 100 further includes one or more sensors 130.

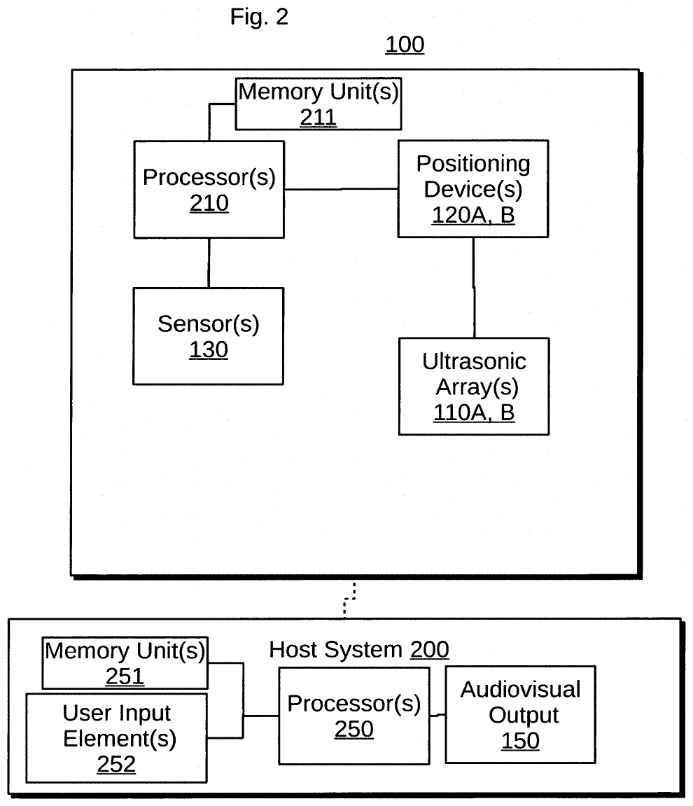

FIG. 2 is a schematic illustration showing additional aspects of a haptic effect remote projection system 100 according to an embodiment, as well as a host system 200 with which the haptic effect remote projection system 100 communicates. As illustrated in FIG. 2, the haptic effect remote projection system 100 further includes at least one processor 210 and at least one memory unit 211. In embodiments, the haptic effect remote projection system 100 is in communication with a host system 200. The host system 200 includes at least one processor 250, at least one memory unit 251, and at least one audiovisual output 150. The audiovisual output 150 includes a display screen 151 (illustrated in FIG. 1) such as a computer monitor or television as well as an audio output(s), including a speaker(s) and/or headphone(s) (not shown). In further embodiments, the audiovisual output 150 may include a projector, a head-mounted display device configured for providing three dimensional stereoscopic VAMR images.

In example embodiments described herein, the haptic effect remote projection system 100 includes at least one processor 210 configured to carry out tasks related to the provision of remote haptic effects. The haptic effect remote projection system 100 is in communication with the host system 200, which is configured to run software applications. The at least one processor 250 of the host system 200 communicates application information to the processor 210 for the remote provision of haptic effects. The at least one processor 250 of the host system may also receive any and all information collected by or generated by the haptic effect remote projection system 100, including orientation and control signals generated by the processor 210 as well as target object information collected by the sensor 130. The described arrangement is by way of example only. The various tasks described as carried out by the haptic effect remote projection system processor 210 and the host system processor 250 may be interchangeably carried out. In embodiments, the processor 210 and/or the processor 250 may carry out any or all of the tasks described with respect to either processor. For example, the processor 250 of the host system may be configured to perform the tasks of the haptic effect remote projection system 100 in addition to running software applications and/or the processor 210 may be configured to perform the tasks of running an interactive software application and provide output to the audiovisual output 150.

The haptic effect remote projection system 100 and the host system 200 are special purpose computer systems programmed and configured to carry out tasks described herein. Computer systems consistent with the present invention may be configured as a gaming console, a handheld gaming device, a personal computer (e.g., a desktop computer, a laptop computer, etc.), a smartphone, a tablet computing device, a television, an interactive sign, and/or other programmable computing device. The computer systems may include one or more processors (also interchangeably referred to herein as processors, processor(s), or processor for convenience), one or more memory units, audiovisual outputs, user input elements, and/or other components as described herein. Computer system processors may be programmed by one or more computer program instructions to carry out methods described herein.

The haptic effect remote projection system 100 and the host system 200 each include one or more processors 210, 250, one or more memory units 211, 251, and/or other components. The processors 210, 250 are programmed by one or more computer program instruction stored in the memory units 211, 251. The functionality of the processors 210, 250, as described herein, may be implemented by software stored in the memory units 211, 251 or another computer-readable or tangible medium, and executed by the processors 210, 250. As used herein, for convenience, the various instructions may be described as performing an operation, when, in fact, the various instructions program the processors 210, 250 to perform the operation. In other embodiments, the functionality of the processor may be performed by hardware (e.g., through the use of an application specific integrated circuit (“ASIC”), a programmable gate array (“PGA”), a field programmable gate array (“FPGA”), etc.), or any combination of hardware and software.

The various instructions described herein may be stored in the memory units 211, 251, which may comprise random access memory (RAM), read only memory (ROM), flash memory, and/or any other memory suitable for storing software instructions. The memory units 211, 251 may store the computer program instructions (e.g., the aforementioned instructions) to be executed by the processors 210, 250 as well as data that may be manipulated by the processors 210, 250.

The host system 200 includes one or more user input elements 252 that may include any elements suitable for accepting user input. These may include buttons, switches, dials, levers, touchscreens, and the like. A user input element(s) 252 may further include peripherally connected devices, such as mice, joysticks, game controllers, keyboards, and the like. In further embodiments, the user input element(s) 252 may include cameras, lidar devices, radar devices, and/or other devices for remotely determining gestures made by a user and for remotely determining position and movement of body parts of a user. In embodiments, the sensors 130 may function as the user input element(s) 252.

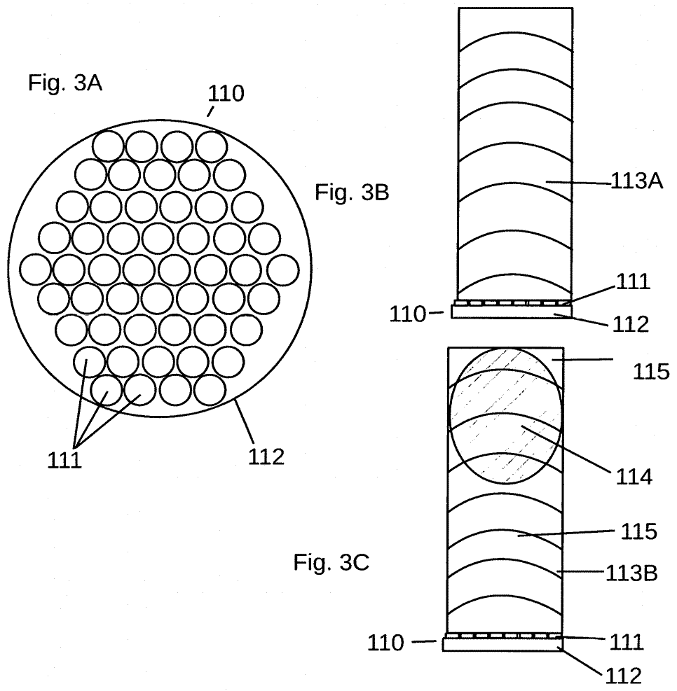

FIGS. 3A-3C illustrate an ultrasonic array 110, corresponding to the ultrasonic arrays 110A, 110B, and operational aspects thereof. The ultrasonic array 110 includes a plurality of ultrasonic transducers 111 located on a mounting surface 112 and configured to produce an ultrasonic beam when activated together. An ultrasonic beam is a focused, high frequency, e.g., greater than 18 kHz, projection of sound waves. Sound waves are pressure waves that travel through a medium, such as air or water. At sufficient sound pressures, sound waves cause physical sensations when intersecting/interacting with part(s) of a human body. The high frequency of ultrasonic waves is outside a normal range of human hearing.

The ultrasonic transducers 111 may be located on the mounting surface 112 in various configurations. As illustrated in FIGS. 3A-3C, the ultrasonic transducers 111 are located on the circular mounting surface 112 in a flat arrangement. In further embodiments, the mounting surface 112 may be convex or concave or may have an alternative curvature. In further embodiments, the mounting surface 112 may be triangular, square, rectangular, hexagonal, or any other suitable shape.

In accordance herewith, and as illustrated in FIGS. 3B and 3C, the plurality of ultrasonic transducers 111 are arranged in an array to project the high frequency sound waves in an ultrasonic beam 113A, 113B. Each of the plurality of ultrasonic transducers 111 are configured to produce ultrasonic sound waves. The plurality of ultrasonic transducers 111 are activated and/or oriented within the array such that the ultrasonic sound waves combine through constructive and destructive interference to generate regions of increased and decreased sound pressure to form the ultrasonic beam 113A, 113B.

As illustrated in FIG. 3B, the plurality of ultrasonic transducers 111 may be configured, for example, to generate an ultrasonic beam 113A extending from the ultrasonic array 110 as a focused column of increased sound pressure sufficient to cause a perceptible sensation or haptic effect. The focused ultrasonic beam 113A does not spread out significantly with increasing distance from the ultrasonic array 110. In this example, contact between the ultrasonic beam 113A and portion(s)/part(s) of a human body, anywhere along the length of the ultrasonic beam 113A, causes a perceptible sensation, or haptic effect.

As illustrated in FIG. 3C, the plurality of ultrasonic transducers 111 may also be configured, for example, to generate an ultrasonic beam 113B with varying levels of sound pressure throughout. Thus, a perceptible portion 114 of the ultrasonic beam 113B located a distance away from the ultrasonic array 110 may have a sound pressure sufficient to cause a haptic effect while imperceptible portions 115 of the ultrasonic beam 113B may have sound pressures insufficient for perception. In this example, contact between the ultrasonic beam 113B and portion(s)/part(s) of a human body, will only cause a perceptible sensation or haptic effect in the perceptible portion 114 of sufficiently increased sound pressure. The ultrasonic transducers 111 may be configured and activated to produce perceptible portions 114 of varying sizes. As illustrated in FIG. 3C, the perceptible portion 114 may be relatively large compared to the ultrasonic beam 113B. In further embodiments, the perceptible portion 114 may be relatively small compared to the ultrasonic beam 113B.

The focused ultrasonic beam 113A, 113B can project high-pressure sound waves farther than an unfocused beam (i.e., because the sound energy does not spread out as much) and can be used to project the high-pressure sound waves along a well-defined path. With the foregoing understanding in mind, the ultrasonic array 110 is configured to project a focused beam of sound that cannot be heard or seen by humans to cause a perceptible sensation, e.g., a haptic effect, on a body part, or haptic target, of a human. Accordingly, the ultrasonic array 110 is configured to remotely project a haptic effect.

The haptic effect projected by the ultrasonic array 110 is projected a distance of between approximately 1 cm to 1 m from the ultrasonic array 110. The size of the focused ultrasonic beam 113A, 113B projected by the ultrasonic array 110 is dependent upon the size and configuration of the ultrasonic array 110 itself. In embodiments, the ultrasonic array 110 may be sized, shaped, and activated so as to produce an ultrasonic beam 113A, 113B between approximately 1 cm and 20 cm across. The ultrasonic array 110 may be sized, shaped, and activated, so as to produce a circular beam, a square beam, a rectangular beam, and/or any other suitably shaped beam. The ultrasonic array 110 may be sized, shaped, and activated to produce remote volumes of increased sound pressure of varying sizes and shapes. In embodiments, the ultrasonic array 110 may be sized, shaped, and activated to produce beams of greater or smaller size and to have larger projection distances, as may be required.

Returning now to FIGS. 1 and 2, the one or more sensor 130 is configured to detect the presence, location, and motion of one or more target objects and to output a signal including target object information. The sensor 130 may be a camera, motion sensor, radar device, lidar device, and or any other device suitable for detecting the presence and motion of an object. The sensor 130 generates a raw data signal based on the detection of the presence, location, and motion of an object. The sensor 130 is configured to output target object information based on the raw data signal about the presence, location, and motion of any detected target object(s). In an embodiment, the target object information is refined information generated by a processor associated with the sensor 130 through analysis and interpretation of the raw data signal. The target object information may thus include information describing the presence, location, and motion of a target object(s) detected by the sensor 130. In an embodiment, the target objection information includes the raw data signal generated by the sensor, and is output to the processor 210 of the haptic effect remote projection system 100 for analysis and interpretation.

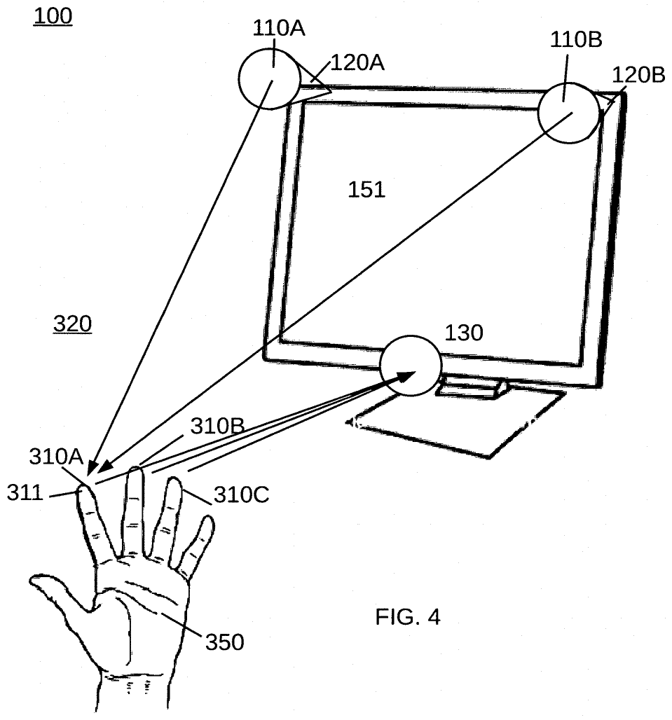

The positioning devices 120A, 120B are electromechanical devices configured to adjust an orientation and/or a position of the corresponding ultrasonic arrays 110A, 110B. The positioning devices 120A, 120B, as illustrated in FIG. 1, are motorized, multi-axis gimbals permitting the orientation of the ultrasonic arrays 110A, 110B in two axes, e.g., pitch and yaw. In further embodiments, as discussed below with respect to FIGS. 4-7, the positioning devices 120A, 120B may also include single axis or triple axis gimbals, translation devices such as rails and/or robotic arms, aerial drones, as well as combinations of these and/or any other device suitable for adjusting the orientation and/or position of the ultrasonic arrays 110A, 110B. As illustrated in FIG. 1, the haptic effect remote projection system 100 includes two ultrasonic arrays 110A, 110B, each with a corresponding positioning device 120A, 120B, and one sensor 130. This arrangement is by example only, and the haptic effect remote projection system 100 may include any number of ultrasonic arrays, corresponding positioning devices, and sensors.

The processor 210 of the haptic effect remote projection system 100 is in wired or wireless electronic communication with the ultrasonic arrays 110A, 110B, the positioning devices 120A, 120B, and the one or more sensors 130. The processor 210 is in further communication with the at least one memory unit 211. The haptic effect remote projection system 100 is configured for wired or wireless communication with the host system 200. The host system 200 may include, for example, a desktop computer, a laptop computer, a tablet computer, and any other computing device. In embodiments, the haptic effect remote projection system 100 is integrated with the host system 200, and the processor 210 and memory unit 211 carry out all of the functions described herein with respect to processor 250 and memory unit 251. Specific descriptions herein refer to the haptic effect remote projection system 100 for remote projection of haptic effects and the host system 200 as separate computing systems. For all embodiments of haptic effect remote projection system 100 described herein as a separate system, corresponding embodiments exist that include an integration between the haptic effect remote projection system 100 and the host system 200.

FIG. 4 illustrates operation of the haptic effect remote projection system 100 for remote projection of haptic effects according to an embodiment. In the embodiment of FIG. 4, the ultrasonic arrays 110A, 110B are mounted on two-axis gimbal positioning devices 120A, 120B at opposing corners of the display screen 151. The area in front of the display screen 151 is established as a haptically enabled interaction volume 320. The haptically enabled interaction volume 320 is defined as the volume in which the one or more sensors 130 can detect the presence, location, and/or movement of a target object(s) and in which the ultrasonic arrays 110A, 110B can project haptic effects perceptible to a human. As discussed above, the ultrasonic beam projected by the ultrasonic arrays 110A, 110B can be projected for a finite distance. Based on the orientation and positioning of the ultrasonic arrays 110A, 110B by the positioning devices 120A, 120B and an effective detection volume of the sensor 130, a volume of effective haptic projection can be determined. This is the haptically enabled interaction volume 320. The haptically enabled interaction volume 320 extends past the sides, top, and bottom of the display screen 151.

The haptically enabled interaction volume 320 may be limited by potential positioning and orientation of the ultrasonic arrays 110A, 110B, as well as their projection strength. Ultrasonic arrays 110A, 110B able to project haptic effects at a greater distance may thus establish a larger haptically enabled interaction volume 320. Positioning devices 120A, 120B configured to orient and position the ultrasonic arrays 110A, 110B to target a greater volume may also establish a larger haptically enabled interaction volume 320. A larger number of ultrasonic arrays 110A, 110B may further establish a larger haptically enabled interaction volume 320. For example, multiple ultrasonic arrays positioned throughout a booth or a room may establish a haptically enabled interaction volume 320 large enough for an entire human body. In embodiments, the haptically enabled interaction volume 320 may be limited to volumes in which two or more ultrasonic arrays are able to provide perceptible haptic effects.

A user may interact with the haptic effect remote projection system 100 for remote projection of haptic effects as follows. The user places a body part, such as hand 350 in the haptically enabled interaction volume 320. The sensor 130 detects the presence of target objects 310A, 310B, 310C, shown in FIG. 4 as individual figures of the hand 350. Target objects detected by the sensor 130 can include any and all objects and/or portions of objects inside the haptically enabled interaction volume 320. The sensor 130 provides the target object information to the processor 210. The target object information may be provided as a continuous stream and/or in discrete amounts. In embodiments, the sensor 130 provides all collected target object information to the processor 210. In further embodiments, the sensor 130 provides selected target object information to the processor 210 based on requests made by the processor 210. As discussed above, the target object information may include raw data collected by the sensor 130 and/or may include refined data after interpretation by a processor associated with the sensor 130. The target object information may be provided as a continuous stream and/or in discrete amounts. The target object information includes at least the presence and location of the target objects 310A, 310B, 310C, and may further include motion vectors of the target object 310A, 310B, 310C.

The processor 210 selects one or more haptic target from among the target objects according to the target object information. The processor 210 uses the target object information to identify one or more haptic targets for receiving haptic effects.

In embodiments, the haptic target is selected according to both target object information and to application information supplied by the host system 200, according to an application operating on the host system 200. Application information describes user interaction with a software application operating on the host system 200 and includes information, data, and commands generated by the software application. For example, in a software application that involves a virtual contact between one of the target objects 310A, 310B, 310C and a virtual object generated by the software, the application information may include information about which of the multiple target objects 310A, 310B, 310C initiated the virtual contact. The host system 200 communicates the application information to the processor 210. The haptic target is selected according to user interaction with the application operating on the host system 200. For example, a user may be interacting with a menu system shown on the display screen 151 by the application operating on the host system 200. The user may be using an index finger, i.e., target object 310A, to interact with the application operating on host system 200. As discussed above, information from the sensor 130 may be supplied to the host system as user input information. The index finger, i.e., target object 310A, may be selected as the haptic target 311 because it is the finger being using for menu system interactions. Accordingly, feedback provided to the user during the menu system interaction may be directed towards the index finger, serving as the haptic target 311.

The processor 210 determines the location of the haptic target 311 according to the target object information received from the sensor 130. The processor 210 uses the target object information to determine the location and, in some cases, motion, of the haptic target 311 as it moves within the haptically enabled interaction volume 320.

The processor 210 provides an orientation signal to either or both of positioning devices 120A, 120B. The orientation signal is configured to cause the positioning devices 120A, 120B to orient the ultrasonic arrays 110A, 110B towards the haptic target. The orientation signal may be provided on a continuous basis to maintain the orientation of the ultrasonic arrays 110A, 110B towards the haptic target 311 as it is moved within the haptically enabled interaction volume 320. The positioning devices 120A, 120B receive the orientation signal and operate to orient the mounted ultrasonic arrays 110A, 110B towards the haptic target 311. Orienting towards the haptic target 311 may include rotational and/or positional translation of the ultrasonic arrays 110A, 110B. The orientation signal provides information necessary for each respective positioning device 110A, 110B to orient its associated ultrasonic array 110A, 110B towards the haptic target 311. In embodiments, processor 210 provides an orientation signal including direct positioning commands that cause operation of positioning device motors to perform the orientation. In embodiments, processor 210 provides an orientation signal including information about the haptic target 311 location and/or movement to a processor associated with the positioning devices 120A, 120B and the processor of the positioning devices 120A, 120B determines the necessary positioning commands to perform the orientation.

The processor 210 provides a control signal to either or both ultrasonic arrays 110A, 110B to cause the ultrasonic arrays 110A, 110B to emit an ultrasonic beam to cause a haptic effect at the haptic target 311. The ultrasonic beam is projected from the ultrasonic array 110A, 110B to remotely cause a haptic effect. One or both of the ultrasonic arrays 110A, 110B may be activated to project an ultrasonic beam for causing the haptic effect. Characteristics of the projected ultrasonic beam or beams may be altered to produce different haptic effects. For example, the magnitude, sonic frequency, pulse length, and/or pulse pattern may be altered to change the strength and sensation caused by the ultrasonic beam. The control signal may be configured by the processor 210 to cause the intended haptic effect.

In embodiments, the control signal and the orientation signal may be combined to cause haptic effects. The orientation signal may be configured to cause movement of the positioning devices 120A, 120B during projection of the ultrasonic beam, thus causing movement of the haptic effect as it is being projected.

In embodiments, the processor 210 alters the control signal and the orientation signal to adjust for obstructed target objects. Depending on the positioning of the ultrasonic arrays 110A, 110B, a “line-of-sight” path between one or more ultrasonic arrays 110A, 110B and the haptic target 311 may be obstructed. For example, the back of a user's hand may obstruct a line-of-sight path to the palm of the user's hand from one of the ultrasonic arrays 110A, 110B but not the other, where the palm is intended as the haptic target 311. In such a case, the processor 210 configures the orientation signal to orient the ultrasonic array 110A, 110B having an unobstructed path towards the haptic target 311 before delivering the control signal to cause the haptic effect. In embodiments, the orientation signal is configured to cause movement of one or more of the positioning device 120A, 120B and their corresponding ultrasonic arrays 110A, 110B to achieve an unobstructed line-of-sight to the haptic target 311.

A user may interact with the haptic effect remote projection system 100 for remote projection of haptic effects as follows. The user may launch and operate a software application running on host system 200. For example, the user may operate modeling software. Display screen 151 displays a model in two dimensions. The user places their hands in the haptically enabled interaction volume 320, where they are tracked by sensor 130. The sensor 130 generates target object information based on the placement and movement of the user's hands and communicates the target object information to the processor 210 of the haptic effect remote projection system 100 and to the processor 250 of the host system 200. The host system 200 uses the target object information as input to the modeling software application, displaying a virtual pair of hands representing the user's hands on the display screen 151. When the virtual hands contact the virtual model, the host system 200 communicates application information about the virtual contact to the processor 210 of the haptic effect remote projection system 100. The processor 210 of the haptic effect remote projection system 100 employs the information about the virtual contact to select a haptic target 311 from among the target objects 310A, 310B, 310C identified in the target object information. The haptic target 311 may be selected, for example, based on the body part of the user that corresponds to the virtual body part making virtual contact with the model. Having selected a haptic target 311, the processor 210 of the system provides the orientation signal to the positioning devices 120A, 120B. The positioning devices 120A, 120B, based on the orientation signal, orient the ultrasonic arrays 110A, 110B towards the haptic target. The processor 210 of the system provides a control signal to at least one of the ultrasonic arrays 110A, 110B, where the control signal is configured to cause at least one of the ultrasonic arrays 110A, 110B, to emit an ultrasonic beam with characteristics defined by the control signal. The ultrasonic arrays 110A, 110B, then emit an ultrasonic beam targeting the haptic target 311, i.e., the user's fingers that are making virtual contact with the model, to provide a haptic effect. Thus, as the user moves their hands in the haptically enabled interaction volume 320 to virtually interact with the displayed model, the haptic effect remote projection system 100 provides haptic feedback to the fingers that are virtually interacting with the model, providing the user with a more immersive sensation.

In embodiments, the processor 210 may determine potential haptic targets from among the targets objects identifiable from the target object information. The processor 210 may provide an orientation signal to maintain the ultrasonic arrays pointed in the general direction of the multiple potential target objects before a specific haptic target is selected. For example, a user's arms, going back to the elbow, may be inside the haptically enabled control volume 320. The processor 210 may determine that the user's fingers or hands are more likely than the user's forearms to become haptic targets, for example, based on application information received from the host system 200. Thus, the user's fingers or hands may be designated as potential haptic targets. The processor may provide an orientation signal that maintains an orientation of the ultrasonic arrays 110A, 110B towards the potential haptic targets, e.g., towards an averaged location of the multiple potential haptic targets. Thus, less movement of the ultrasonic arrays 110A, 110B is required when a haptic target is identified for receiving a haptic effect.

In embodiments, the audiovisual output 150 may include an image projection and/or a headset configured to provide the user with a simulated VAMR view. In a VAMR embodiment, the user may see his/her hands or a representation of his/her hands interacting with the model while the haptic effect remote projection system 100 projects haptic effects to those portions of the hands in virtual contact with the model.

By way of example only, the preceding description refers, in some portions, to haptic effects provided to a single haptic target. In embodiments, haptic effects may be provided to multiple haptic targets simultaneously, and the processor 210 may track multiple haptic targets via the target object information of the sensor 130 and provide the requisite orientation signals and control signals to cause haptic effects at the multiple haptic targets. In embodiments, the positioning devices 120A, 120B may be instructed by the processor 210 to each orient a respective ultrasonic array 110A, 110B towards a different haptic target and/or a different set of potential haptic targets. For example, the ultrasonic array 110A, located at the top left of the display screen 151, may be instructed to maintain an orientation towards the fingers of the right hand, while the ultrasonic array 110B, located at the top right of the display screen 151, may be instructed to maintain an orientation towards the fingers of the left hand.

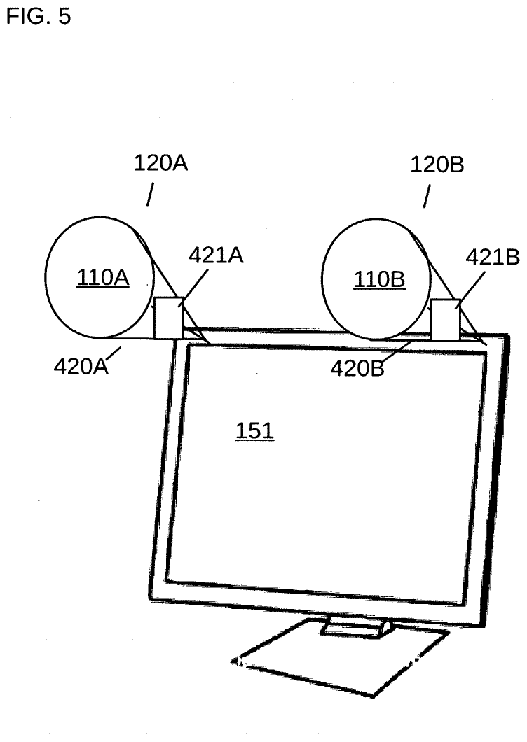

FIG. 5 illustrates further details of positioning devices 120A, 120B according to an embodiment. The positioning devices 120A, 120B include gimbals 420A, 420B. The gimbals 420A, 420B are two-axis gimbals configured for rotation through the pitch and yaw axes. In further embodiments, single-axis gimbals configured for rotation through a pitch or yaw axis or three-axis gimbals configured for rotation through pitch, roll, and yaw axes are provided with the positioning devices 120A, 120B. The positioning devices 120A, 120B further include one or more actuators 421A, 421B. The actuators 421A, 421B are configured to rotate the two-axis gimbals 420A, 420B of the positioning devices 120A, 120B to orient the ultrasonic arrays 110A, 110B mounted on the positioning devices 120A, 120B. The actuators 421A, 421B may each include one or more motors configured to cause rotation of the gimbals 420A, 420B. The actuators 421A, 421B are in wired or wireless communication with the processor 210. In embodiments, the positioning devices 120A, 120B may include local processors configured to receive the orientation signal from the processor 210 and provide a signal to the actuators 421A, 421B to rotate the multi-axis gimbal to orient the ultrasonic arrays 110A, 110B. In embodiments, the actuators 421A, 421B receive the orientation signal directly from the processor 210. The gimbaled positioning devices of FIG. 5 are by way of example only. In further embodiments, any suitable electromechanical device for controlling orientation may operate as a positioning device.

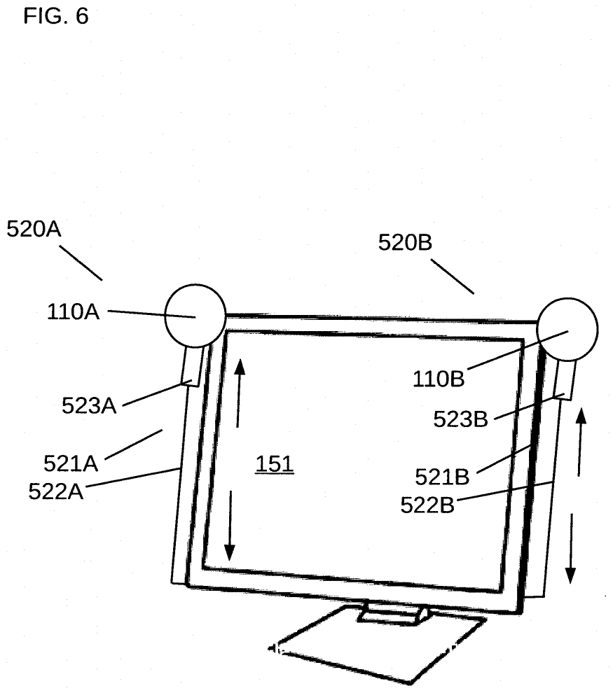

FIG. 6 illustrates positioning devices according to another embodiment. The positioning devices 520A, 520B, upon which are mounted the ultrasonic arrays 110A, 110B, include translation actuators 521A, 521B. The positioning devices 520A, 520B are positioned at lateral sides of the display screen 150. The positioning devices 520A, 520B are configured to translate the ultrasonic array from a first location to a second location. The translation actuators 521A, 521B comprise rails 522A, 522B and carriages 523A, 523B. The carriages 523A, 523B are motorized to translate the ultrasonic arrays 110A, 110B to any location along the rail. In embodiments, the positioning devices 520A, 520B include local processors configured to receive the orientation signal from the processor 210 and provide a signal to the actuators 521A, 521B to drive the carriages 523A, 523B. In embodiments, the actuators 521A, 521B receive the orientation signal directly from the processor 210. The translational positioning devices of FIG. 6 are by way of example only. In further embodiments, any suitable electromechanical device for translating the ultrasonic arrays 110A, 110B may operate as a positioning device. Examples include lead screws, hydraulic devices, rack and pinion devices, geared devices, and others.

In embodiments, positioning devices may include both gimbal devices configured for directional orientation of the ultrasonic arrays 110A, 110B and translational devices configured to translate a location of the ultrasonic arrays 110A, 110B. In embodiments, the ultrasonic arrays 110A, 110B may be mounted to different types of positioning devices.

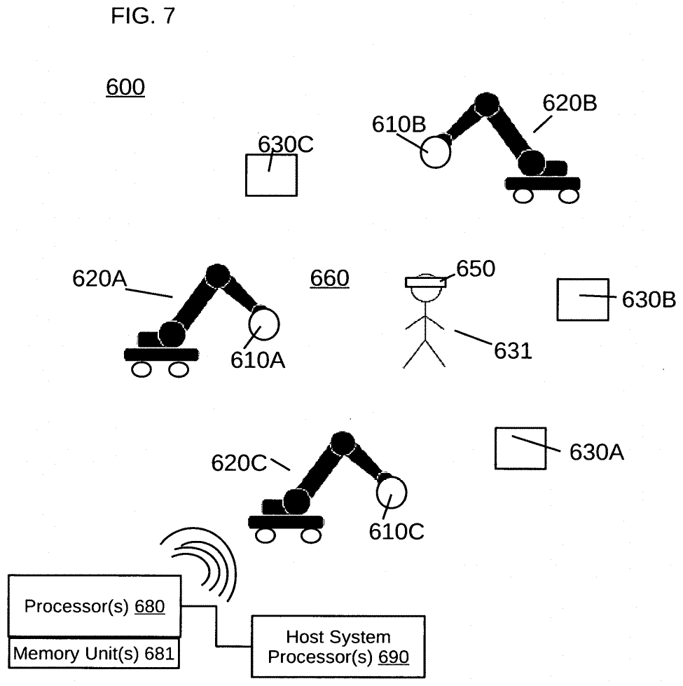

FIG. 7 illustrates a haptic effect remote projection system 600 for remote projection of haptic effects according to an embodiment. The haptic effect remote projection system 600 provides a full life-size immersive VAMR experience to a human user. The range of the haptic effect remote projection system 600 defines a haptically enabled interaction volume 660, sized to accommodate the entire body of a human user and permit their movement through the haptically enabled interaction volume 660. The human user wears a VAMR display 650 within the haptically enabled interaction volume 660. The human user may engage with and interact with a VAMR application providing visual display through the VAMR display 650. The haptic effect remote projection system 600 includes at least one positioning device 620A, 620B, 620C, at least one ultrasonic array 610A, 610B, 610C, at least one sensor 630A, 630B, 630C, and at least one processor 680 associated with at least one memory unit 681. Similar to the haptic effect remote projection system 100, the at least one processor 680 is electrically coupled, wired or wirelessly, to the at least one positioning device 620A, 620B, 620C, the at least one ultrasonic array 610A, 610B, 610C, and the at least one sensor 630A, 630B, 630C. The at least one processor 680 receives target object information from the sensor(s) 630A, 630B, and 630C, identifies a haptic target 631, provides orientation signals to the positioning device(s) 620A, 620B, 620C, and provides control signals to the ultrasonic array(s) 610A, 610B, 610C. The at least one processor 680 is capable of performing each of the same functions as the processor 210 with respect to the component parts of the haptic effect remote projection system 600. The at least one processor 680 may be in communication with a host system processor 690 configured to run software applications with which a user may interact via the VAMR headset 650 and/or may itself be configured to run software applications with which a user may interact.

The at least one positioning device 620A, 620B, 620C may include multiple positioning devices located throughout the haptically enabled interaction volume 660, each with a corresponding ultrasonic array 610A, 610B, 610C mounted thereon. In an embodiment hereof, the positioning devices 620A, 620B, 620C are electromechanical motion devices, including one or more actuators configured to orient and position the ultrasonic arrays 610A, 610B, 610C throughout the room in which the haptic effect remote projection system 600 is located The sensors 630A, 630B, 630C may be located in fixed positions throughout the room in which the haptic effect remote projection system 600 is located, may be mounted on positioning devices similar to the positioning devices 620A, 620B, 620C, and/or may be mounted on the positioning devices 620A, 620B, 620C themselves. The positioning devices 620A, 620B, 620C may include robotic arms having one to four degrees of freedom of movement mounted on rails or wheeled carts providing two degrees of freedom of movement around the floor of the system room. The positioning devices 620A, 620B, 620C may further include any other electromechanical device configured to orient and position corresponding ultrasonic arrays 610A, 610B, 610C, such as rails, pivots, gimbals, etc.

A user wears a VAMR display 650 and moves through the haptically enabled interaction volume 660, virtually interacting with a software application running on the host system processor 690 and displayed via the VAMR display 650. The host system processor 690 receives input based on the user's actions, including, for example, target object information from the sensors 630A, 630B, 630C, information about the user from sensors, such as cameras, radar devices, lidar devices, etc., associated with the host system processor 690, and input from control devices operated by the user. The user's inputs and interactions with the software may be captured via a handheld device or controller, by a camera system, by a radar system, by a lidar system, and/or by any other suitable input means. For example, a camera system may be used to capture the movements and gestures of the user and interpret these as inputs. In another example, the user may carry a controller that includes input devices and motion detection devices. As the user interacts with the software application, haptic effects are delivered by the haptic effect remote projection system 600 through the ultrasonic arrays 610A, 610B, 610C. The haptic effect remote projection system 600, accordingly, is configured to deliver a fully immersive VAMR experience including haptic effects. Although the user may wear a haptically enabled wearable device in embodiments, such a wearable is not required. In embodiments in which a haptically enabled wearable device is employed, the haptic effect remote projection system 600 delivers haptic effects to areas of the body that are not targeted by the wearable device.

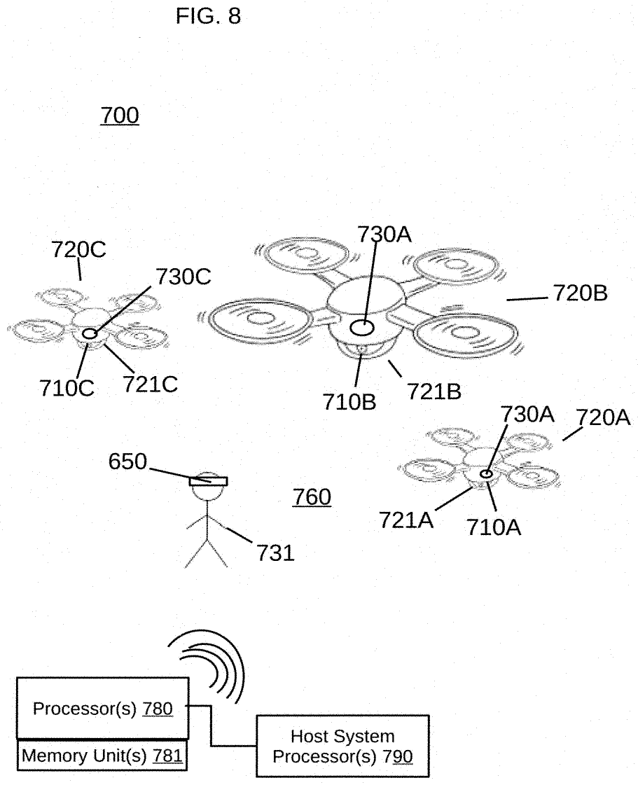

FIG. 8 illustrates a haptic effect remote projection system 700 for remote projection of haptic effects according to another embodiment. The haptic effect remote projection system 700, similar to the haptic effect remote projection system 600, provides a full life-size immersive VAMR experience to a human user. The haptic effect remote projection system 700 defines a haptically enabled interaction volume 760, sized to accommodate the entire body of a human user and permit his/her movement throughout. The human user wears a VAMR display 650 within the haptically enabled interaction volume 760 and engages with and interacts with a VAMR application run by the host system processor 790 providing visual display through the VAMR display 650. Aspects of the haptic effect remote projection system 700, including multiple positioning devices 720A, 720B, 720C, ultrasonic arrays 710A, 710B, 710C, and sensors 730A, 730B, 730C, are in communication with a processor 780. The processor 780 is configured to provide the required orientation and control signals to system aspects in similar fashion as described above with respect to the processors 210 and 680. The processor 780 is capable of all of the same functions as described above with respect to processors 210 and 680.

In the haptic effect remote projection system 700, the multiple positioning devices 720A, 720B, 720C, to which the ultrasonic arrays 710A, 710B, 710C are respectively mounted, are aerial drones. Sensors 730A, 730B, 730C may be mounted to the positioning devices 720A, 720B, 720C and/or to additional aerial drones that do not carry ultrasonic arrays 710A, 710B, 710C. The aerial drone positioning devices 720A, 720B, 720C further include orientation actuators 721A, 721B, 721C, are capable of flight and are configured to move throughout the haptically enabled interaction volume 760 to deliver the ultrasonic arrays 710A, 710B, 710C to appropriate respective locations and orientations within the haptically enabled interaction volume 760. The aerial drone positioning devices 720A, 720B, 720C serve to move the ultrasonic arrays 710A, 710B, 710C to appropriate locations throughout the interaction volume 760 and the orientation actuators 721A, 721B, 721C serve to orient the ultrasonic arrays 710A, 710B, 710C appropriately. The orientation actuators 721A, 721B, 721C may include, for example, single-axis or multi-axis gimbal devices and/or single-axis or multi-axis pivot devices. Using both aerial drone capabilities and the capabilities of the orientation actuators 721A, 721B, 721C, the positioning devices 720A, 720B, 720C are configured to position and orient the ultrasonic arrays 710A, 710B, 710C within the haptically enabled interaction volume 760 so as to deliver an ultrasonic beam for causing haptic effects at a haptic target selected by the processor 780. The haptic target 731 may be selected by the processor 780 from among a plurality of target objects in similar fashion as that described above with respect to the processor 210. The processor 780 may control the positioning devices directly and/or may communicate with local processors that are configured for performing movement and orientation tasks.

In embodiments, the system 700 further includes positioning devices 620A, 620B, 620C as described above. For example, positioning devices 620A, 620B, 620C may be located in portions of the haptically enabled interaction volume 660 where they are most likely to be able to provide the appropriate haptic effects according to the software application operating on the host system processor 790. Positioning device 720A, 720B, 720C are employed to provide haptic effects when the user moves outside of these expected areas.

In embodiments, the haptic effect remote projection system 700 is employed flexibly to turn any room or space, including outdoor spaces, into a haptically enabled interaction volume 760. The mobility of the aerial drone positioning devices 720A, 720B, 720C expands the interaction volume 760 to any volume in which the sensors 730A, 730B, 730C are able to track target object information and the positioning devices 720A, 720B, 720C are able to maintain the ultrasonic arrays 710A, 710B, 710C in a targeting orientation. Because the aerial drones are capable of movement, the interaction volume 760 may be expanded to encompass significant volumes of space.

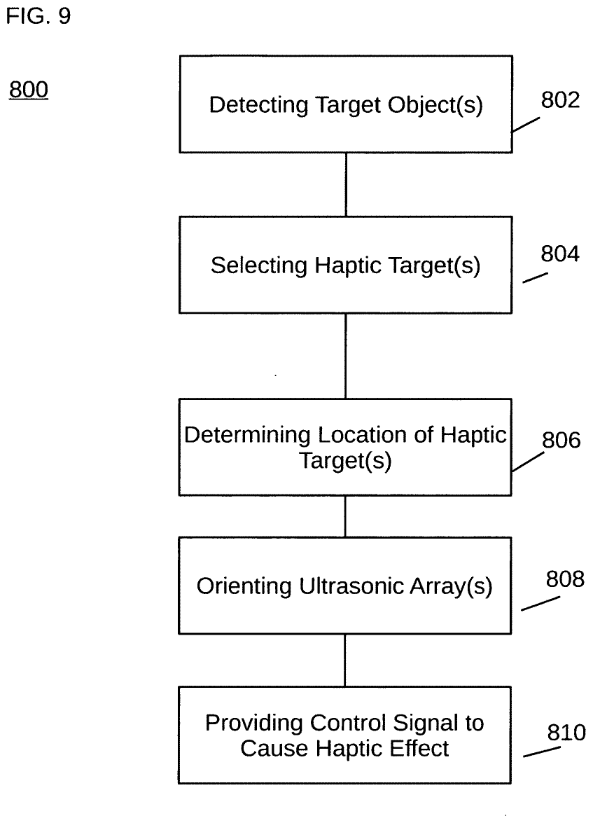

FIG. 9 illustrates a process 800 for remote projection of haptic effects according to an embodiment. The process 800 of FIG. 9 may be carried out by any of the haptic effect remote projection systems 100, 600, 700, described herein, and/or by any combination of aspects of the described systems. In embodiments, the functionality of the process diagram of FIG. 9 may be implemented by software and/or firmware stored in the memory units 211, 681, 781, and executed by the processors 210, 680, 780 of the haptic effect remote projection systems 100, 600, 700. In embodiments, functionality of the process diagram of FIG. 9 may be carried out by processors 210, 681, 781 associated with the haptic effect remote projection systems 100, 600, 700 and/or by processors 250, 690, 790 associated with interactive host systems.

In a target object detecting operation 802, the process 800 for remote projection of haptic effects includes detecting, via one or more sensors, one or more target objects. The one or more sensors output target object information related to the one or more detected target objects. The sensors may be, for example, cameras, LIDAR devices, radar devices, and/or any other suitable device for detecting the presence, location, and movement of objects.

In a haptic target selecting operation 804, the process 800 for remote projection of haptic effects includes selecting a haptic target from among one or more target objects. A haptic effect remote projection system processor receives the target object information output by the one or more sensors. The haptic effect remote projection system processor analyzes and interprets the target object information to select a haptic target from among the target objects. In embodiments, the haptic target is selected according to application information of the operation of a software application running a host system processor in communication with the processor of the haptic effect remote projection system. In embodiments, the software application runs on the processor of the haptic effect remote projection system.

In a location determining operation 806, the process 800 for remote projection of haptic effects includes determining, with the system processor, the location of the haptic target or targets. The location is determined based on the target object information received from the one or more sensors. In embodiments, the haptic effect remote projection system processor may also determine a movement vector of the haptic target or targets.

In an ultrasonic array orienting operation 808, the process 800 for remote projection of haptic effects includes orienting one or more ultrasonic arrays towards the haptic target. The haptic effect remote projection system processor determines an orientation signal according to the determined location of the haptic target and the location of the ultrasonic array to be oriented. In embodiments, the haptic effect remote projection system processor may further determine the orientation signal according to the movement vector of the haptic target to account for potential movement of the haptic target. The haptic effect remote projection system processor provides the orientation signal to the positioning devices of one or more ultrasonic arrays. Actuators of the positioning devices respond to the orientation signal to orient corresponding ultrasonic arrays according to the received orientation signal.

In a haptic effect control signal providing operation 810, the process 800 for remote projection of haptic effects includes providing a control signal to remotely project a haptic effect via at least one ultrasonic beam produced by at least one ultrasonic array. The haptic effect remote projection system processor provides a control signal to the ultrasonic array. According to the control signal, the ultrasonic array produces an ultrasonic beam configured to cause a haptic effect when it intersects/interacts with the haptic target. One or more ultrasonic arrays may be used to produce the haptic effects. Multiple ultrasonic arrays may be used to create stronger and/or more varied haptic effects. For example, multiple ultrasonic arrays may be used to create haptic effects that move across the haptic target, merging and separating. The control signal may be configured to alter that characteristics of the haptic effect. Characteristics of the haptic effect may be modified via modification of the ultrasonic beam, including modification of the sonic frequency, pulse rate and pattern, and amplitude of the ultrasonic beam.

### Additional Discussion of Various Embodiments

Embodiment 1 a system for projecting haptic effects, comprising
an ultrasonic array mounted on a positioning device;
a sensor configured to detect a target object and output target object information; and
a processor configured to:
   receive the target object information from the sensor,
   select a haptic target according to the target object information,
   determine a location of the haptic target based on the target object information,
   provide an orientation signal to the positioning device, the orientation signal being configured to cause the positioning device to orient the ultrasonic array towards the haptic target, and
   provide a control signal to cause the ultrasonic array to emit an ultrasonic beam to cause a haptic effect at the haptic target.

Embodiment 2 is the system of embodiment 1, wherein the positioning device includes a multi-axis gimbal configured to rotate, and at least one actuator configured to receive the orientation signal and to rotate the multi-axis gimbal and orient the ultrasonic array in response to the orientation signal.

Embodiment 3 is the system of embodiment 2, wherein the multi-axis gimbal is a three-axis gimbal.

Embodiment 4 is the system of any of embodiments 1-3, wherein the positioning device includes a translation actuator configured to receive the orientation signal and translate the ultrasonic array from a first location to a second location.

Embodiment 5 is the system of any of embodiments 1-4, wherein the ultrasonic array includes a first ultrasonic array and a second ultrasonic array.

Embodiment 6 is the system of embodiment 5, wherein the first and second ultrasonic arrays are positioned at opposing corners or lateral sides of a display screen.

Embodiment 7 is the system of any of embodiments 1-6, wherein the positioning device includes a robotic arm.

Embodiment 8 is the system of any of embodiments 1-7, wherein the positioning device includes an aerial drone.

Embodiment 9 is the system of any of embodiments 1-8, wherein the sensor includes a camera.

Embodiment 10 is the system of any of embodiments 1-9, wherein the target object includes a plurality of target objects and the processor is further configured to select the haptic target from among the plurality of target objects according to the target object information and application information describing user interaction with a software application.

Embodiment 11 is a method for projecting haptic effects comprising:
detecting, with a sensor, a target object;
outputting, with the sensor, target object information related to the target object;
receiving, with a processor, the target object information from the sensor;
selecting, with the processor, a haptic target according to the target object information;
determining, with the processor, a location of the haptic target based on the target object information;
providing, with the processor, an orientation signal to a positioning device;
orienting, with the positioning device, an ultrasonic array according to the orientation signal; and
providing, with the processor, a control signal configured to cause the ultrasonic array to cause a haptic effect at the haptic target.

Embodiment 12 is the method of embodiment 11, wherein orienting the ultrasonic array includes controlling a multi-axis gimbal of the positioning device.

Embodiment 13 is the method of any of embodiments 11-12, wherein orienting the ultrasonic array includes controlling a translation actuator of the positioning device.

Embodiment 14 is the method of any of embodiments 11-13, wherein the ultrasonic array includes a plurality of ultrasonic arrays, the method further comprising controlling the orientation of the plurality of ultrasonic arrays.

Embodiment 15 is the method of any of embodiments 11-14, wherein detecting the target object includes detecting the target object with a camera.

Embodiment 16 is the method of any of embodiments 11-15, further comprising selecting the haptic target with the processor according to the target object information and application information describing user interaction with a software application.

Embodiment 17 is the method of any of embodiments 11-16, further comprising determining the location of the haptic target within a haptically enabled interaction volume.

Embodiment 18 is the method of any of embodiments 11-17, wherein the haptically enabled interaction volume is a volume in front of a display screen.

Embodiment 19 is the method of any of embodiments 11-18, wherein the haptically enabled interaction volume is a room.

Thus, there is provided systems, devices, and methods of remotely projecting haptic effects. While various embodiments according to the present invention have been described above, it should be understood that they have been presented by way of illustration and example only, and not limitation. It will be apparent to persons skilled in the relevant art that various changes in form and detail can be made therein without departing from the spirit and scope of the invention. Thus, the breadth and scope of the present invention should not be limited by any of the above-described exemplary embodiments, but should be defined only in accordance with the appended claims and their equivalents. It will also be understood that each feature of each embodiment discussed herein, and of each reference cited herein, can be used in combination with the features of any other embodiment. Aspects of the systems, devices, and methods of projecting remote haptic effects may be used in any combination with other methods described herein or the methods can be used separately. All patents and publications discussed herein are incorporated by reference herein in their entirety

What is claimed is:

1. A system for projecting haptic effects, comprising
an ultrasonic array mounted on a positioning device;
a sensor configured to detect a target object and output target object information; and
a processor configured to
receive the target object information from the sensor,
select a haptic target according to the target object information,
determine a location of the haptic target based on the target object information,
provide an orientation signal to the positioning device, the orientation signal being configured to cause the positioning device to orient the ultrasonic array towards the haptic target, and
provide a control signal to cause the ultrasonic array to emit an ultrasonic beam to cause a haptic effect at the haptic target.

2. The system of claim 1, wherein the positioning device includes a multi-axis gimbal configured to rotate, and at least one actuator configured to receive the orientation signal and to rotate the multi-axis gimbal and orient the ultrasonic array in response to the orientation signal.

3. The system of claim 2, wherein the multi-axis gimbal is a three-axis gimbal.

4. The system of claim 1, wherein the positioning device includes a translation actuator configured to receive the orientation signal and translate the ultrasonic array from a first location to a second location.

5. The system of claim 1, wherein the ultrasonic array includes a first ultrasonic array and a second ultrasonic array.

6. The system of claim 5, wherein the first and second ultrasonic arrays are positioned at opposing corners or lateral sides of a display screen.

7. The system of claim 1, wherein the positioning device includes a robotic arm.

8. The system of claim 1, wherein the positioning device includes an aerial drone.

9. The system of claim 1, wherein the sensor includes a camera.

10. The system of claim 1, wherein the target object includes a plurality of target objects and the processor is further configured to select the haptic target from among the plurality of target objects according to the target object information and application information describing user interaction with a software application.

11. A method for projecting haptic effects comprising:
detecting, with a sensor, a target object;
outputting, with the sensor, target object information related to the target object;
receiving, with a processor, the target object information from the sensor;
selecting, with the processor, a haptic target according to the target object information;
determining, with the processor, a location of the haptic target based on the target object information;
providing, with the processor, an orientation signal to a positioning device;
orienting, with the positioning device, an ultrasonic array according to the orientation signal; and
providing, with the processor, a control signal configured to cause the ultrasonic array to cause a haptic effect at the haptic target.

12. The method of claim 11, wherein orienting the ultrasonic array includes controlling a multi-axis gimbal of the positioning device.

13. The method of claim 11, wherein orienting the ultrasonic array includes controlling a translation actuator of the positioning device.

14. The method of claim 11, wherein the ultrasonic array includes a plurality of ultrasonic arrays, the method further comprising controlling the orientation of the plurality of ultrasonic arrays.

15. The method of claim 11, wherein detecting the target object includes detecting the target object with a camera.

16. The method of claim 11, further comprising selecting the haptic target with the processor according to the target object information and application information describing user interaction with a software application.

17. The method of claim 11, further comprising determining the location of the haptic target within a haptically enabled interaction volume.

18. The method of claim 17, wherein the haptically enabled interaction volume is a volume in front of a display screen.

19. The method of claim 17, wherein the haptically enabled interaction volume is a room.
